(19) United States
(12) Patent Application Publication
(10) Pub. No.: US 2026/0187855 A1
(43) Pub. Date: Jul. 2, 2026

(54) IMAGE GENERATION USING PROMPT CHAINS

(71) Applicant: Google LLC, Mountain View, CA (US)

(72) Inventors: Krista Lynn Holden, Santa Clara, CA (US); Garima Pruthi, Santa Clara, CA (US)

(21) Appl. No.: 18/859,072

(22) PCT Filed: Aug. 2, 2024
(86) PCT No.: PCT/US2024/040757

§ 371 Date: Oct. 22, 2024

Related U.S. Application Data
(60) Provisional application No. 63/517,496, filed on Aug. 3, 2023.

(51) Int. Cl. G06T 11/00; G06T 7/90

(52) U.S. Cl. CPC G06T 11/00; G06T 7/90; G06T 2207/20081; G06T 2207/20084

(57) ABSTRACT

Methods, systems, and apparatus, including computer programs encoded on a computer storage medium, for enabling artificial intelligence to generate new images of environments and to generate digital components based on the images are described. In one aspect, a method includes generating, by an artificial intelligence system, a first prompt that includes a set of attributes of an item and first instructions that instruct a language model to generate one or more environments that visually convey the set of attributes. The artificial intelligence system receives, as an output of the language model, data indicating the one or more environments. The artificial intelligence system generates, for each environment of the one or more environments, a second prompt that includes second instructions that instruct an image generation model to generate one or more images of the environment. The artificial intelligence system provides each second prompt as an input to the image generation model.

### CROSS-REFERENCE TO RELATED APPLICATIONS

This application claims priority of U.S. Provisional Application No. 63/517,496 filed Aug. 3, 2023. The prior application is incorporated herein by reference in its entirety and for all purposes.

### BACKGROUND

This specification relates to data processing, artificial intelligence, and generating images using artificial intelligence.

### SUMMARY

In general, one innovative aspect of the subject matter described in this specification can be embodied in methods that include the actions of generating, by an artificial intelligence system, a first prompt that includes a set of attributes of an item and first instructions that instruct a language model to generate one or more environments that visually convey the set of attributes; receiving, by the artificial intelligence system and as an output of the language model, data indicating the one or more environments; generating, by the artificial intelligence system and for each environment of the one or more environments, a second prompt that includes second instructions that instruct an image generation model to generate one or more images of the environment; providing, by the artificial intelligence system, each second prompt as an input to the image generation model; receiving, by the artificial intelligence system, a set of images generated by the image generation model, the set of images comprising, for each second prompt, one or more images of the environment corresponding to the second prompt generated by the image generation model using the second prompt; generating, by the artificial intelligence system, a digital component that includes a particular image selected from the set of images; and providing, by the artificial intelligence system, the digital component to a client device of a user. Other implementations of this aspect include corresponding apparatus, systems, and computer programs, configured to perform the aspects of the methods, encoded on computer storage devices.

These and other embodiments can each optionally include one or more of the following features. In some aspects, the first instructions include a name of the item.

In some aspects, generating, by the artificial intelligence system and for each environment of the one or more environments, a second prompt that includes second instructions that instruct the image generation model to generate the one or more images of the environment includes providing, for each environment of the one or more environments, a third prompt to the language model, the third prompt including third instructions that instruct the language model to generate the image generation prompt based on the environment.

In some aspects, the third instructions instruct the language model to generate a close up image of the environment.

In some aspects, the image generation prompt for each environment includes contextual information generated by the language model and that describes the environment.

Some aspects include extracting the set of attributes of the item from one or more documents related to the item. Extracting the set of attributes of the item can include providing, to the language model, a prompt that instructs the language model to output the set of attributes based on content of the one or more documents.

Some aspects include receiving data indicating a particular color or emotion to be emphasized in each image of an environment. Generating, by the artificial intelligence system and for each environment of the one or more environments, the second prompt can include modifying a prompt template to include additional instructions to instruct the image generation model to emphasize the particular color or emotion in each image of an environment generated by the image generation model.

Some aspects include receiving a selection of a size of the item. Generating, by the artificial intelligence system and for each environment of the one or more environments, the second prompt can include modifying a prompt template to include additional instructions to instruct the image generation model to generate an image of an environment corresponding to the size of the item.

In some aspects, modifying the prompt template includes adding one or more phrases corresponding to the size of the item.

Some aspects include selecting the particular image from the set of images based on one or more performance measures for the image.

Some aspects include providing each image in the set of images and the second prompt used to generate the image to a machine learning model trained to output data indicating a level of match between the image and the second prompt used to generate the image and selecting the particular image based on the level of match for each image in the set of images.

Some aspects include receiving a component request from the client device of the user. The artificial intelligence system can generate the first and second prompts and the digital component after receiving the component request.

Some aspects include receiving a component request from the client device of the user. The artificial intelligence system can generate the first prompt prior to receiving the component request and generate each second prompt and the digital component after receiving the component request.

In some aspects, the second instructions of each second prompt includes data of the component request.

Particular embodiments of the subject matter described in this specification can be implemented so as to realize one or more of the following advantages. The techniques described in this document create prompts for one or more machine learning models to generate images, e.g., images of environments, based on a set of attributes of an item. A digital component can be generated by adding an image of the item to the image of the environment and/or adding a link to a landing page for the item. It's challenging to accurately convey the attributes of an item in an image, even when using image generation machine learning models. The prompt generation techniques described in this document instruct machine learning models, e.g., language models, to identify environments that convey a set of attributes of an item and to generate suitable images of the identified environments. The use of language models in this way results in images that more accurately convey the attributes of the items in a fast and computational efficient manner. This also results in the creation of images of new environments that humans may not have the capability to create.

For example, absent the described techniques, a user would have to either create the images manually or attempt to generate prompts for machine learning models that result in images that do not accurately convey attributes of an item. Using inaccurate prompts results in multiple requests to the machine learning models to arrive at a suitable image, which wastes the resources used to execute the machine learning models, which can preclude the models from being used for other tasks. This also consumes memory resources required to store images that are not of suitable quality and to send multiple images over a network for a user to view the images at a client device before arriving at a suitable image. This wastes network bandwidth and can introduce latency in the network.

In general, language models, especially general purpose large language models, are not adapted to understanding conceptual things such as human emotions or metaphors. Thus, current language models are not capable of creating images that convey such concepts using a single prompt with a set of attributes that include such concepts. For example, if a language model is prompted to generate an image that shows an item while conveying emotions of Christmas, the resulting image may be the item shaped like a Christmas tree or the item in green and red, rather than the item under a Christmas tree.

The techniques described in this document overcome the deficiencies of current language models by breaking down the image generation process into a chain of prompts that guide one or more AI models to generate a list of environments based on attributes and then generate images of those environments, resulting in images that more accurately convey conceptual attributes and that are of higher visual quality. For example, a first prompt constrains the parameters and outputs of the model to a less complex task of identifying environments that match a set of attributes as compared to creating entire images based on the attributes which could include any type of content that may or may not be relevant to the attributes. A second prompt can then instruct the model (or another model) to generate images of these environments.

In addition, the prompts in the prompt chain include instructions that are configured to properly constrain the models to provide high quality output images that accurately convey the attributes. This provides more fine-tuned control over the parameters of the model(s) and the outputs of the model(s), resulting in higher quality images and less processing than single prompt image generation.

The prompt chains described in this document also reduce hallucinations in the model outputs. For example, each prompt is configured to constrain the parameters used by the model to generate each output and to constrain the outputs themselves. This results in far fewer hallucinations compared to using a single less constrained prompt that instructs the model to generate images that reflect attributes directly.

In addition to preventing hallucinations and other inaccuracies resulting from a less constrained prompt, the constraints of the prompts in the prompt chains reduce the amount of computing resources used for the model(s) to process each prompt. For example, limiting the output to a list of environments and then images of those environments results in less overall processing than causing the model(s) to generate any type of images that conveys the attributes directly using a single prompt.

By prompting the model(s) to generate a list of environments that convey a set of attributes and then prompting the model(s) to generate images of those environments results in a tree like hierarchy of different images that convey the attributes. Each image can be processed to determine the highest quality (e.g., most accurate) image and that image can be used to generate the digital component. This results in a wider breadth of images that convey the same attributes in different ways, which can all be used to provide varying digital components and/or to ensure that the selected image results in a high quality digital component.\

The machine models are techniques for using the machine learning models are adapted to generate the images and digital components using the images in milliseconds, which enables the images and digital components to be generated in real time on a per-request basis, e.g., in response to a user query. Absent the described techniques, the images would need to be generated in advance and would not be adapted to a user's current contextual environment and would require vast amounts of memory resources to store all of the images. Thus, the described techniques reduce the burden placed on computing systems and results in more accurate images that more accurately convey a set of attributes.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which images and digital components are generated and distributed to client devices.

FIG. 2 is a block diagram illustrating interactions between an artificial intelligence system, a language model, an image generation model, and a client device.

FIG. 3 is a flow chart of an example process of generating images of environments and digital components based on a generated image.

FIG. 4 a block diagram of an example computer.

Like reference numbers and designations in the various drawings indicate like elements.

### DETAILED DESCRIPTION

This specification describes techniques for enabling artificial intelligence to generate new images of environments and to generate digital components based on the images. Artificial intelligence (AI) is a segment of computer science that focuses on the creation of models that can perform tasks with little to no human intervention. Artificial intelligence systems can utilize, for example, machine learning, natural language processing, or computer vision. Machine learning, and its subsets, such as deep learning, focus on developing models that can infer outputs from data. The outputs can include, for example, predictions and/or classifications. Natural language processing, focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

The techniques described throughout this document enable artificial intelligence to generate new digital components based on images of environments that convey a set of one or more attributes of an item that is the subject of the digital component. The techniques can be performed in real time, e.g., in response to a component request, such that new images of environments can be used for each individual digital component presented to users. Using the described techniques, items can be shown in environments that more accurately reflect the qualities and/or other attributes of the item.

The system can use a chain of prompts to instruct machine learning models to generate an image based on the attributes of the item. For example, the system can generate a first prompt (which can also be referred to as an environment prompt) that instructs a language model, e.g., a large language model (LLM) to identify environments that convey the attributes of the item. The output of the language model in response to the environment prompt can be a list of environments. The system can generate, for each environment, a second prompt (which can also be referred to as an image generation prompt) that instructs an image generation model to generate one or more images of the environment. To generate an image generation prompt, the system can provide a third prompt (which can also be referred to as a prompt generation prompt) to the language model. The prompt generation prompt can instruct the language model to generate an image generation prompt based on an environment and optionally additional information, such as whether the image should be a close up image, what objects should or should not be depicted in the image, contextual information for the environment (which can be generated by the language model based on the prompt generation prompt), and/or other information.

As described in more detail below, the prompt chain is specialized (e.g., created or augmented) to improve the overall quality of the images generated by the image generation model. Post-processing operations are then used to evaluate the generated images against each other to determine which images have higher quality than other images (e.g., given the attributes of the item). One or more of the images are used to generate digital components. For example, the system can generate a digital component by adding an image of the item or text related to the item to an image of an environment. One or more of the digital components generated using the higher quality images are output to a computing device (e.g., user computer, mobile device, tablet device, audio device, gaming device, etc.).

The post-processing operations can include, for example, evaluating the images based on various criteria, and scoring each of the images based on the evaluation. For example, one post-processing operation can perform a prediction regarding the performance of a digital component that is based on the image. Another post-processing operation can evaluate the level of match between the image and the image generation prompt and/or the image and the attributes of the item. The post-processing operations can also use various heuristics to evaluate different characteristics of each of the images, and the scores can be assigned based on the various heuristics. In some implementations, the scores are weighted and aggregated to create a final score, which is used to select an image for the set of images. For example, a performance score and a match score can be generated, weighted, and combined to determine a final score for each image. Additionally, or alternatively, one or more machine learning models can be trained to score image quality, performance, and/or match, and those scores can be used to select from the images. One or more of the highest scoring images are then selected for use in generating digital components.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

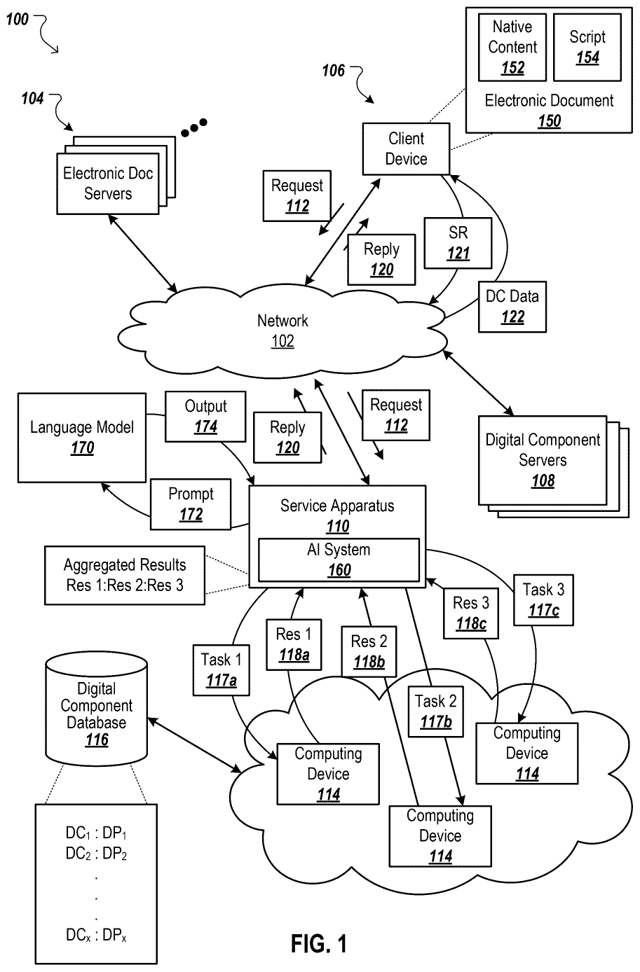

FIG. 1 is a block diagram of an example environment 100 in which generative artificial intelligence can be implemented. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection).

Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents.

Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided. The techniques described in this document enable the creation of new digital components based on images of environments in real time while avoiding errors and user frustration.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an artificial intelligence system 160 configured to autonomously generate digital components, either prior to a request 112 (e.g., offline) and/or in response to a request 112 (e.g., online or real-time). As described in more detail throughout this specification, the artificial intelligence (“AI”) system 160 can collect online content about a specific entity (e.g., digital component provider or another entity) and use the collected online content to generate images of environments using machine learning modules, e.g., language models 170, which can include large language models.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens.

The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

In some implementations, the AI system 160 can generate a prompt 172 that is submitted to the language model 170, and causes the language model 170 to generate the output sequences 174, also referred to simply as “output”. The AI system 160 can generate the prompt in a manner (e.g., having a structure) that instructs the language model 170 to generate the output. In some implementations, the AI system 160 can be configured to generate prompts using prompt templates. Each prompt template can include instructions that instruct the language model to generate an output based on the instructions. Each prompt template can include customizable fields that can be customized with additional information for the language model 170 to use in generating the output. For example, the fields can be customized by populating the fields with a set of attributes of an item, the name of an environment, or other words or phrases, as described in more detail below.

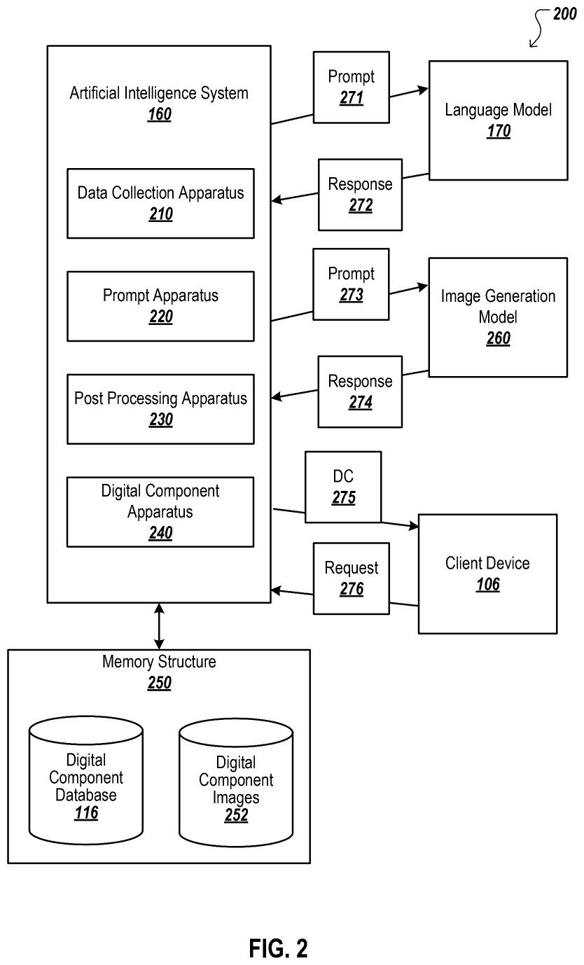

The AI system 160 can be configured to generate a prompt chain that is submitted to the language model 170 in a sequence. A prompt chain includes a sequence of prompts that break down a task for the language model 170 into multiple smaller tasks and enables the prompts to build on previous outputs of the language model 170. In some implementations, the AI system 160 can use defined prompt chains that include a sequence of prompt templates to generate image generation prompts for an image generation model 260 (FIG. 2).

For example, a prompt chain can include a first prompt template for identifying environments that convey attributes of an item and a second prompt template for generating image generation prompts for the image generation model 260. In other words, the first prompt template can be used to generate an environment prompt and the second prompt template can be used to generate a prompt generation prompt. In general, the output of this example prompt chain is one or more image generation prompts that the AI system 160 can provide to the image generation model 260 to generate images of environments. Prompt chains and prompt templates are described in more detail below with reference to FIG. 2.

The AI system 160 can generate digital components using the images generated by the image generation model 260 using the image generation prompts. For example, the AI system 160 can generate a digital component by adding an image of an item and/or text related to the item to an image of an environment. The service apparatus 110 can provide the digital components to client devices 106, e.g., in response to requests 112.

Although a single language model 170 is shown in FIG. 1, different language models can be specially trained to process different prompts at different stages of the processing pipeline. For example, a more general (e.g., larger) language model can be used to generate a list of environments for an item as an offline process (e.g., independent of receipt of the request 112), which can then be inserted into prompts (e.g., prompt generation prompts and/or image generation prompts) that are input to a more specialized and faster language model in an online process (e.g., real-time in response to receiving the request 112). Additionally, the AI system 160 can generate a set of images of environments as an offline process (e.g., prior to receiving the request 112, and store the set of images in a database. In this scenario, when the AI system 160 receives the request 112, the AI system 160 can further evaluate, rank, and/or modify the stored images based on additional information included in the request and other contextual data (e.g., time of day, day of week, weather conditions, etc.).

FIG. 2 is a block diagram illustrating interactions between an artificial intelligence system 160, a language model 170, an image generation model 260, and a client device 106. The AI system 160 includes a data collection apparatus 210, a prompt apparatus 220, a post processing apparatus 230, and a digital component apparatus 240. The AI system 160 can include or be coupled to a memory structure 250 that can store the digital component database 116 and/or digital component images data store 252. The apparatuses of the AI system 160 can be implemented using a single computer or multiple networked computers. The memory structure 250 can include one or more databases or other data structures stored on one or more memories and/or data storage devices.

The data collection apparatus 210 is configured to collect data related to items and/or digital components for the items. For example, the data collection apparatus 210 can obtain, from digital component providers, digital components, distribution parameters, and other information for the digital components and store the digital components and information in the memory data structure 250. The data collection apparatus 210 can also obtain information about items that are subjects of the digital components from the digital components or other resources, e.g., by crawling web pages and/or application pages for the items, and store the information in the digital component database 116. The data collection apparatus 210 can also obtain images of the items and/or digital components from the digital component provider or resources, or from the digital components for the items and store the images in the digital component images data store 252.

The prompt apparatus 220 is configured to generate prompts 271 and to provide the prompts 271 to one or more machine learning models, e.g., to one or more language models 170 and/or to one or more image generation models 260. As described above, the prompt apparatus 220 can generate prompts 271 by populating prompt templates, e.g., prompt templates of a prompt chain that includes a first prompt template for identifying environments that convey attributes of an item and a second prompt template for generating image generation prompts for the image generation model 260. For each prompt, the prompt apparatus 220 can receive a response 272 from the language model 170. Each response 272 can include an output generated by the language model 170 based on the prompt 271.

The first prompt template can include instructions that instruct the learning model to identify environments that convey attributes of an item. The first prompt template can also include fields for the attributes, a field for text describing the product (e.g., a name or type of the item), and or other information about the item. For example, the first prompt template can include: “List five visually descriptive environments that [description] can be used that match [attributes]. Give just the environments in a bulleted list and no extra context.” In this example, the text “[description]” is a field in which the text describing the item can be inserted and the text “[attributes]” in which the list of attributes of the item can be inserted. The remaining text of the first prompt template includes the instructions. For example, if the item is earplugs and the attributes are “quiet, isolated, focused, modern, and sleek,” the prompt apparatus 220 can populate the fields such that the prompt becomes: “List five visually descriptive environments that earplugs can be used that match quiet, isolated, focused, modern, and sleek.”

The prompt apparatus 220 can generate this environment prompt using the first prompt template and the attributes and provide the environment prompt to the language model 170. The language model 170 can output a list of five environments based on the prompt. For example, an output based on the example environment prompt for earplugs described above can include “a library, a study room, an office, a bedroom, a meditation room.”

The prompt apparatus 220 can populate the second prompt template using the identified environments and provide the second prompt template to the language model 170. The second prompt template can include instructions that instruct the learning model to generate image generation prompts for the image generation model 260. The second prompt template can also include fields for one or more environments, a field for customizable instructions (e.g., a field in which instructions corresponding to a size of the item can be inserted) and or other information for use in generating an image generation prompt. For example, the second prompt template can include: “Generate a close up detailed photo image prompt for [environment]. The image should be high quality and there should be no text or people. Give just a single prompt in a bulleted list.” In this example, the text “[environment]” is a field in which the name of an environment output by the language modal can be inserted. The remaining text of the first prompt template includes the instructions. Using the environment “library” as an example, the prompt apparatus 220 can populate the field such that the prompt becomes: “Generate a close up detailed photo image prompt for a library. The image should be high quality and there should be no text or people. Give just a single prompt in a bulleted list.”

The prompt apparatus 220 can generate, for each environment, a prompt generation prompt using the second prompt template and the environment and provide the environment prompt to the language model 170. For each prompt generation prompt, the language model 170 can output an image generation prompt 273 with instructions for generating an image of the environment. For example, an image generation prompt 273 generated for the library can include “A close up photo of a library book shelf, with the spines of the books showing. The books should be in a variety of colors and sizes, and the shelf should be well-lit. The photo should be taken in a way that the books are the focus of the image, and the background is blurred.”

The prompt apparatus 220 can provide the image generation prompt 273 for each environment to the image generation model 260. The image generation model 260 can generate an image based on each image generation prompt 273 and provide a response 274 that includes the image to the prompt apparatus 220. The image generation model 260 can be a text-to-image machine learning model that is trained to generate images based on text input. For example, the image generation model 260 can be implemented as a text-to-image diffusion model. The text input can be referred to as an image generation prompt.

The prompt templates can be customizable. For example, the prompt apparatus 220 can be configured to customize instructions and/or fields of prompt templates or prompts based on the item and/or information related to the item.

For example, the second prompt template for generating prompt generation prompts can be customized based on the size of the item. In this example, the prompt apparatus 220 can be configured to adjust the instructions of the prompt template based on the size of the item. The prompt apparatus 220 can be configured to substitute instructions in the second prompt template based on the size of the item. For each item size or range of sizes, the prompt apparatus 220 can include instructions for inclusion in prompts for items of that size or size range. The prompt apparatus 220 can determine the size of the item based on the name of the item or an image of the item and use the instructions corresponding to that size item when generating the prompt generation prompt. In a particular example, the prompt apparatus 220 can be configured to include the phrase “close up” in the prompt generation prompts for small items, but to not include the phrase “close up” in the prompt generation prompts for large items.

If multiple environments are identified and/or multiple images are generated for each environment, the result of the prompt chain is a set of images of environments that convey the attributes of the item. The post processing apparatus 230 can be configured to evaluate the images to select one or more images for use in generating a digital component based on the image(s).

The post processing apparatus 230 can evaluate the images based on performance and/or match to the image generation prompts used to generate the images. The performance of images can be measured based on user interaction rates (e.g., click-through rates) of digital components generated based on the images and/or conversion rates for the digital components. For example, after an image is generated, the image can be used to generate digital components for the item, as described below. The performance of these digital components can be measured and used to evaluate the images for future digital component generation processes.

The post processing apparatus 230 can also use the performance of similar images to predict the performance of a generated image. For example, the post processing apparatus 230 can evaluate the similarity of a generated image, e.g., using a trained machine learning model, with other images for which performance measurements are available. The post processing apparatus 230 can identify one or more of the most similar images and predict the performance of the generated image using those performance measurements. In one example, the post processing apparatus 230 can use the performance measurement of the most similar image as the predicted performance measurement for the generated image. In another example, the post processing apparatus 230 can aggregate the performance measurements of the top N most similar images, where N is a specified number or a number of images that have at least a threshold similarity with the generated image. The aggregation can be the average of the performance measurements, a weighted average using weights that are proportional to the similarity between the similar image and the generated image, or other measures of central tendency.

The level of match of images can be determined using a machine learning model. For example, a machine learning model can be trained to evaluate the level of match between the image and the image generation prompt. The level of match can be a percentage match or other score that indicates the level of match.

The post processing apparatus 230 can determine an overall score for each image based on the performance and level of match. As described above, each individual measure for an image can be weighted based on importance or other factors when determining the overall score for the image. The post processing apparatus 230 can select one or more images for use in generating a digital component based on the overall score. For example, the post processing apparatus 230 can select each image having at least a threshold score or a predetermined number of the images having the highest scores, e.g., the images corresponding to the three highest overall scores.

The digital component apparatus 240 is configured to generate digital components for items based on the selected image(s). The digital component apparatus 240 can generate a digital component by adding an image of the item or text related to the item to the image. In some implementations, the digital component apparatus 240 can generate an image editing prompt based on the image and the item. For example, the image editing prompt can include instructions for placing the item within the environment. The digital component apparatus 240 can provide the image, an image of the item, and the image editing prompt to the image generation model 260 or a different image editing machine learning model. The model can provide a response that includes an image-based digital component that includes the image of the environment with the item included therein.

In some implementations, the image generation model 260 can generate the digital component using inpainting techniques. For example, the image generation model 260 can be trained using object detectors for generating inpainting masks. Such training allows the image generation model 260 to modify a specific portion of the image to include the image of the item based on the image generation prompt.

The digital component apparatus 240 can be configured to generate the digital component(s) 275 in response to component requests 276 and/or prior to receiving component requests. The digital component apparatus 240 can also be configured to provide the generated digital components 275 to the client device 106 that provided the component request 276.

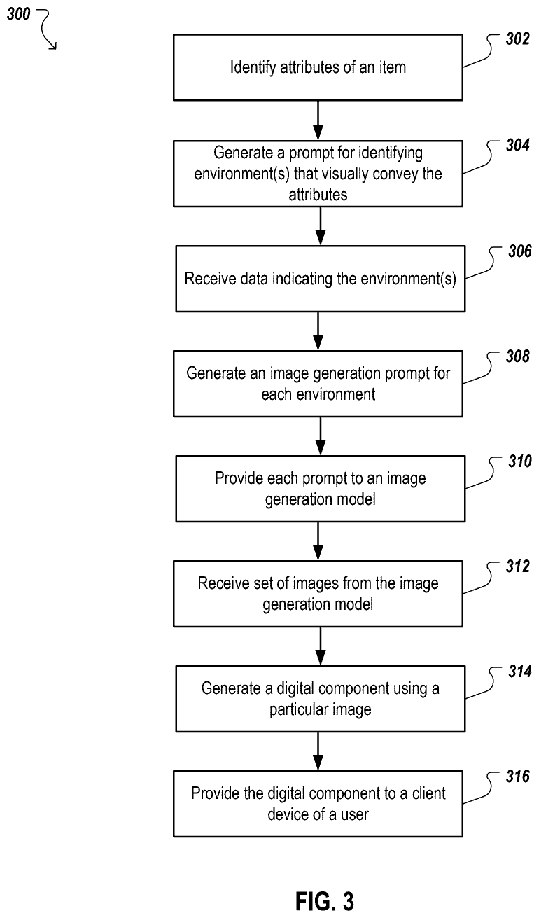

FIG. 3 is a flow chart of an example process 300 of generating images of environments and digital components based on a generated image. Operations of the process 300 can be performed, for example, by the service apparatus 110 of FIG. 1, or another data processing apparatus. The operations of the process 300 can also be implemented as instructions stored on a computer readable medium, which can be non-transitory. Execution of the instructions, by one or more data processing apparatus, causes the one or more data processing apparatus to perform operations of the process 300. For brevity, the process 300 is described as being performed by the service apparatus 110.

The service apparatus 110 identifies one or more attributes of an item (302). The attribute(s) can be provided by a digital component provider that provides digital components for the item. In some implementations, the service apparatus 110 can use a machine learning model to identify the attributes. For example, the service apparatus 110 can provide information about the item to a machine learning model that is trained to output attributes of an item based on the information. In some implementations, the service apparatus 110 is configured to extract keywords from documents that include information about the item and/or text of digital components for the item.

The service apparatus 110 generates a prompt for identifying environments that visually convey the attributes (304). This environment prompt can include instructions that instruct a language model to identify one or more environments that convey the attributes.

As described above, the environment prompt can be generated by populating fields of a prompt template with the identified attributes of the item. In some implementations, the service apparatus 110 can include additional information about the item, such as the name of the item, in the environment prompt, as described above.

The service apparatus 110 receives data indicating one or more environments as an output of the language model (306). The data can be in the form of a list of environments generated by the language model based on the environment prompt.

The service apparatus 110 generates an image generation prompt for each environment identified using the language model (308). In some implementations, the service apparatus 110 uses a language model to generate the image generation prompt(s). For example, the service apparatus 110 can generate a prompt generation prompt that includes instructions for generating an image generation prompt for generating an image of an environment. The service apparatus 110 can provide the prompt generation prompt to the language model and receive, from the language model, the image generation prompt. The service apparatus 110 can perform these operations for each environment to obtain image generation prompts for the environments.

The service apparatus 110 provides each image generation prompt to an image generation model (310). For example, the service apparatus 110 can provide each image generation prompt as a single request for an image.

The service apparatus 110 receives a set of images from the image generation model (312). The set of images can include one or more images generated using each image generation prompt. The image generation model can be configured to output one or more images for each image generation prompt.

The service apparatus 110 generates a digital component based on a particular image in the set of images (314). For example, as described above, the service apparatus 110 can generate a digital component by adding an image of the item or text related to the item to the image. The service apparatus 110 can generate a digital component for each of one or more of the images. In some implementations, the image generation prompt can include instructions to display an image of the item in the environment such that the output images already depicts the item.

In some implementations, the service apparatus 110 generates a digital component creative file that includes the image, metadata, a link to a landing page for the item, and/or code of a digital component. For example, the service apparatus 110 can generate a digital component creative file that includes all of the information and content for the client device to render the digital component. The information and content can include, for example, the image, metadata, and/or code of the selected digital component.

The service apparatus 110 provides the digital component to a client device (316). For example, as described above, the service apparatus 110 can generate and/or provide the digital component in response to a component request received from the client device.

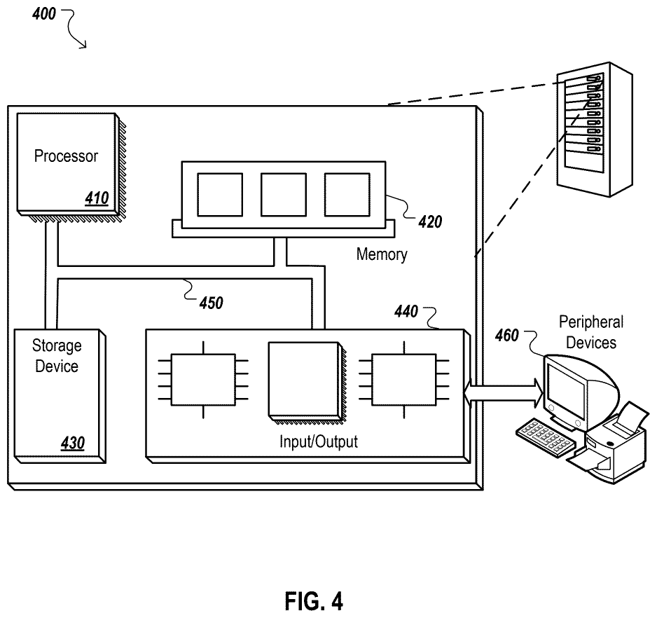

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method, comprising:
generating, by an artificial intelligence system, a first prompt that includes a set of attributes of an item and first instructions that instruct a language model to generate one or more environments that visually convey the set of attributes;
receiving, by the artificial intelligence system and as an output of the language model, data indicating the one or more environments;
generating, by the artificial intelligence system and for each environment of the one or more environments, a second prompt that includes second instructions that instruct an image generation model to generate one or more images of the environment;
providing, by the artificial intelligence system, each second prompt as an input to the image generation model;
receiving, by the artificial intelligence system, a set of images generated by the image generation model, the set of images comprising, for each second prompt, one or more images of the environment corresponding to the second prompt generated by the image generation model using the second prompt;
generating, by the artificial intelligence system, a digital component that includes a particular image selected from the set of images; and
providing, by the artificial intelligence system, the digital component to a client device of a user.

2. The method of claim 1, wherein the first instructions include a name of the item.

3. The method of claim 1, wherein generating, by the artificial intelligence system and for each environment of the one or more environments, a second prompt that includes second instructions that instruct the image generation model to generate the one or more images of the environment comprises providing, for each environment of the one or more environments, a third prompt to the language model, the third prompt including third instructions that instruct the language model to generate the image generation prompt based on the environment.

4. The method of claim 3, wherein the third instructions instruct the language model to generate a close up image of the environment.

5. The method of claim 1, wherein the image generation prompt for each environment comprises contextual information generated by the language model and that describes the environment.

6. The method of claim 1, further comprising extracting the set of attributes of the item from one or more documents related to the item.

7. The method of claim 6, wherein extracting the set of attributes of the item comprises providing, to the language model, a prompt that instructs the language model to output the set of attributes based on content of the one or more documents.

8. The method of claim 1, further comprising receiving data indicating a particular color or emotion to be emphasized in each image of an environment, wherein generating, by the artificial intelligence system and for each environment of the one or more environments, the second prompt comprises modifying a prompt template to include additional instructions to instruct the image generation model to emphasize the particular color or emotion in each image of an environment generated by the image generation model.

9. The method of claim 1, further comprising receiving a selection of a size of the item, wherein generating, by the artificial intelligence system and for each environment of the one or more environments, the second prompt comprises modifying a prompt template to include additional instructions to instruct the image generation model to generate an image of an environment corresponding to the size of the item.

10. The method of claim 9, wherein modifying the prompt template comprises adding one or more phrases corresponding to the size of the item.

11. The method of claim 1, further comprising selecting the particular image from the set of images based on one or more performance measures for the image.

12. The method of claim 1, further comprising:
providing each image in the set of images and the second prompt used to generate the image to a machine learning model trained to output data indicating a level of match between the image and the second prompt used to generate the image; and
selecting the particular image based on the level of match for each image in the set of images.

13. The method of claim 1, further comprising receiving a component request from the client device of the user, wherein the artificial intelligence system generates the first and second prompts and the digital component after receiving the component request.

14. The method of claim 1, further comprising receiving a component request from the client device of the user, wherein the artificial intelligence system generates the first prompt prior to receiving the component request and generates each second prompt and the digital component after receiving the component request.

15. The method of claim 1, wherein the second instructions of each second prompt includes data of the component request.

16. An artificial intelligence system comprising:
one or more processors; and
one or more storage devices storing instructions that, when executed by the one or more processors of the artificial intelligence system, cause the artificial intelligence system to perform operations comprising:
generating a first prompt that includes a set of attributes of an item and first instructions that instruct a language model to generate one or more environments that visually convey the set of attributes;
receiving, as an output of the language model, data indicating the one or more environments;
generating, for each environment of the one or more environments, a second prompt that includes second instructions that instruct an image generation model to generate one or more images of the environment;
providing each second prompt as an input to the image generation model;
receiving a set of images generated by the image generation model, the set of images comprising, for each second prompt, one or more images of the environment corresponding to the second prompt generated by the image generation model using the second prompt;
generating a digital component that includes a particular image selected from the set of images; and
providing the digital component to a client device of a user.

17. A non-transitory computer readable storage medium storing instructions that, when executed by one or more processors of an artificial intelligence system, cause the artificial intelligence system to perform operations comprising:
generating a first prompt that includes a set of attributes of an item and first instructions that instruct a language model to generate one or more environments that visually convey the set of attributes;
receiving, as an output of the language model, data indicating the one or more environments;
generating, for each environment of the one or more environments, a second prompt that includes second instructions that instruct an image generation model to generate one or more images of the environment;
providing each second prompt as an input to the image generation model;
receiving a set of images generated by the image generation model, the set of images comprising, for each second prompt, one or more images of the environment corresponding to the second prompt generated by the image generation model using the second prompt;
generating a digital component that includes a particular image selected from the set of images; and
providing the digital component to a client device of a user.

18. (canceled)
